(19) United States
(12) Patent Application Publication
(10) Pub. No.: US 2017/0117528 A1
(43) Pub. Date: Apr. 27, 2017

(54) RECHARGEABLE BATTERY

(71) Applicant: SAMSUNG SDI CO., LTD., Yongin-si (KR)

(72) Inventors: Ji-Woon LEE, Yongin-si (KR); Eun-Young GOH, Yongin-si (KR); Jin-Hyon LEE, Yongin-si (KR); Sang-In PARK, Yongin-si (KR); Sung-Yong KIM, Yongin-si (KR); Jin-Seon SHIN, Yongin-si (KR); Jong-Ki LEE, Yongin-si (KR)

(21) Appl. No.: 15/213,739

(22) Filed: Jul. 19, 2016

(30) Foreign Application Priority Data
Oct. 23, 2015 (KR) 10-2015-0148212

(51) Int. Cl. H01M 2/26; H01M 10/0525; H01M 2/02; H01M 10/0587

(52) U.S. Cl. CPC H01M 2/263; H01M 10/0587; H01M 10/0525; H01M 2/0202; H01M 2/024; H01M 2220/20; H01M 2220/30

(57) ABSTRACT

Disclosed is a rechargeable battery. The rechargeable battery includes: an electrode assembly including a separator, a first electrode disposed on a first portion of the separator, and second electrodes separated from each other with the separator therebetween; a case for receiving the electrode assembly; a lead tab including a first current collecting tab connected to the first electrode and a second current collecting tab connected to the second electrodes; a first electrode lead connected to the first current collecting tab; and a second electrode lead connected to the second current collecting tab.

### CROSS-REFERENCE TO RELATED APPLICATION

Korean Patent Application No. 10-2015-0148212, filed on Oct. 23, 2015, in the Korean Intellectual Property Office, and entitled: “Rechargeable Battery,” is incorporated by reference herein in its entirety.

### BACKGROUND

1. Field

The described technology relates generally to a rechargeable battery.

2. Description of the Related Art

Unlike a primary battery, a rechargeable battery can be repeatedly recharged and discharged. A small-capacity rechargeable battery is used for small portable electronic devices such as mobile phones, notebook computers, camcorders, and the like, while a large-capacity rechargeable battery is used as a motor-driving power source for a hybrid vehicle.

As typical rechargeable batteries, there are nickel-cadmium (Ni—Cd) batteries, nickel-metal hydride (Ni-MH) batteries, lithium (Li) batteries, lithium ion (Li-ion) batteries, etc. Particularly, the lithium ion rechargeable battery has an operating voltage about thrice as high as that of the Ni—Cd or Ni-MH batteries, which are widely used for power supply of electronic devices. In addition, the lithium ion rechargeable battery has been widely used because its energy density per unit weight is high.

In the rechargeable battery, a lithium-based oxide has been used as a positive active material, and a carbon material has been used as a negative active material. Generally, batteries are classified into a liquid electrolyte battery and a polymer electrolyte battery depending on the type of electrolyte; and lithium batteries using a liquid electrolyte are called lithium ion batteries while batteries using a polymer electrolyte are called lithium polymer batteries.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a rechargeable battery which may include: an electrode assembly including a separator, a first electrode disposed on a first portion of the separator, and a plurality of second electrodes separated from each other with the separator therebetween; a case for receiving the electrode assembly; a lead tab including a first current collecting tab connected to the first electrode and a second current collecting tab connected to the plurality of second electrodes; a first electrode lead connected to the first current collecting tab; and a second electrode lead connected to the second current collecting tab.

The first current collecting tab may be connected to an uncoated region of the first electrode and may protrude from the first electrode to be connected to the first electrode lead.

The second current collecting tab may include a first end connected to the plurality of second electrodes and a protruded end protruding from the plurality of second electrodes, the protruded end may be connected to the second electrode lead.

The second electrodes may be disposed on a lateral side of the separator with different gaps therebetween.

The electrode assembly may be curved at a curved portion where an uncoated region is formed and be spirally wound in a jellyroll shape, and two second electrodes of the plurality of second electrodes may be disposed with the curved portion therebetween and disposed with a largest or greatest gap of the different gaps therebetween.

The second electrodes may be disposed on the lateral side of the separator such that the different gaps increase from an internal side where the spiral winding begins to an external side where the spiral winding finishes.

The second electrodes may be separated from each other and disposed on the lateral side of the separator, and two neighboring second electrodes may be disposed to be inverted from each other when the electrode assembly is spirally wound.

Second current collecting tabs may be a plurality of second current collecting tabs that are welded to and combined with each other when the electrode assembly is spirally wound, the plurality of second current collecting tabs nay be connected to the second electrode lead.

A protrusion may be formed on the lead tab, and an indentation hole into which the protrusion is pressed may be formed in the first electrode lead or the second electrode lead.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view of a rechargeable battery according to a first exemplary embodiment.

FIG. 2 illustrates a perspective view showing that part of an electrode assembly received in a case of a rechargeable battery of FIG. 1 is unfolded.

FIG. 3 illustrates a schematic lateral side view of a spirally wound electrode assembly.

FIG. 4 illustrates a cross-sectional side view of a state in which a first electrode, a separator, and a second electrode of an electrode assembly are disposed.

FIG. 5 illustrates a top plan view of a state in which a first current collecting tab is connected to a first electrode.

FIG. 6 illustrates a top plan view of a state in which a plurality of second electrodes are connected to a plurality of second current collecting tabs.

FIG. 7 illustrates a schematic exploded perspective view of a state in which a lead tab of a rechargeable battery according to a second exemplary embodiment is connected to a first electrode lead or a second electrode lead.

FIG. 8 illustrates a schematic cross-sectional view of a state in which a lead tab of FIG. 7 is connected to a first electrode lead or a second electrode lead.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

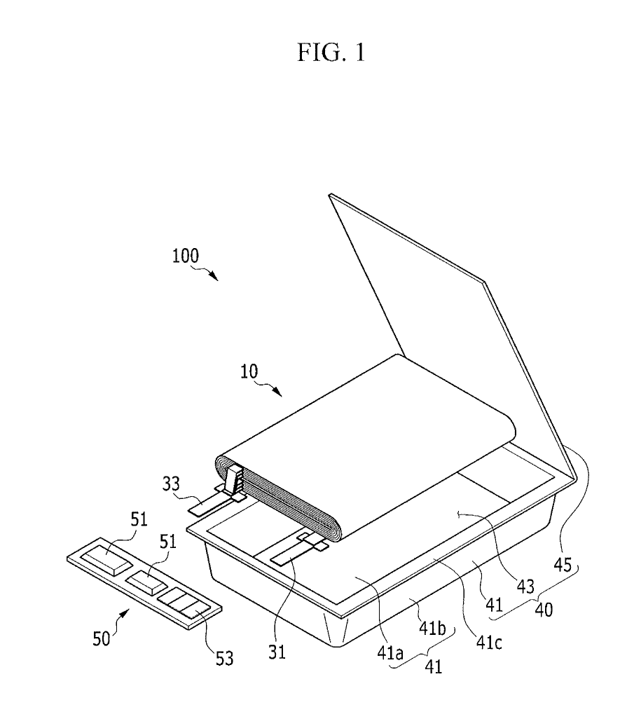

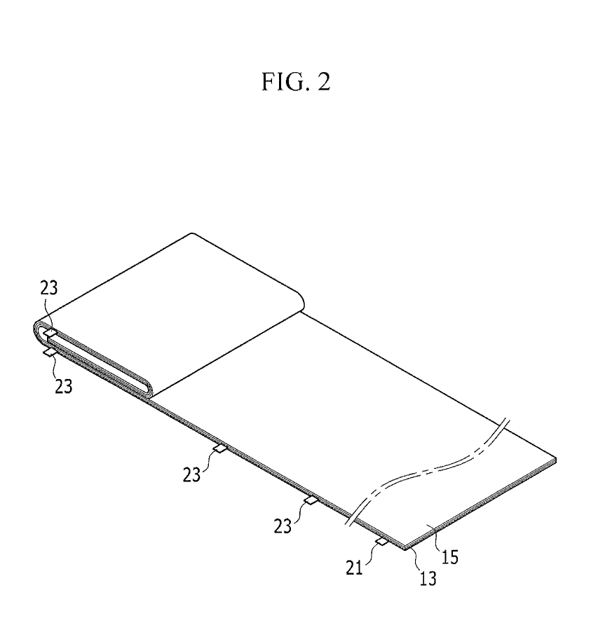

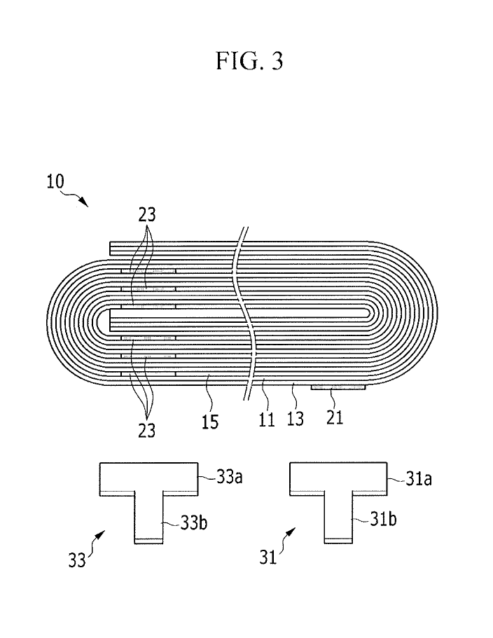

FIG. 1 shows a perspective view of a rechargeable battery according to a first exemplary embodiment, FIG. 2 shows a perspective view illustrating that part of an electrode assembly received in a case of a rechargeable battery of FIG. 1 is unfolded, and FIG. 3 shows a schematic lateral side view of a spirally wound electrode assembly.

As shown in FIG. 1 to FIG. 3, the rechargeable battery 100 includes: an electrode assembly 10 including a first electrode 13 disposed on a first portion of a separator 11 and second electrodes 15 separated from each other with the separator 11 therebetween; a case 40 for receiving the electrode assembly 10; lead tabs 21 and 23 including a first current collecting tab 21 connected to the first electrode 13 and a second current collecting tab 23 connected to the second electrode 15; a first electrode lead 31 connected to the first current collecting tab 21; and a second electrode lead 33 connected to the second current collecting tab 23.

For example, the electrode assembly 10 may be formed by disposing the first electrode (a negative electrode, for example) 13 and the second electrode (a positive electrode, for example) 15 on respective sides of the separator 11, which is an insulator, and spirally winding the negative electrode 13, the separator 11, and the positive electrode 15 as a jellyroll.

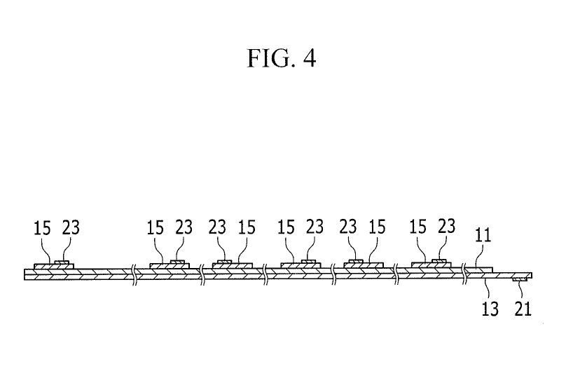

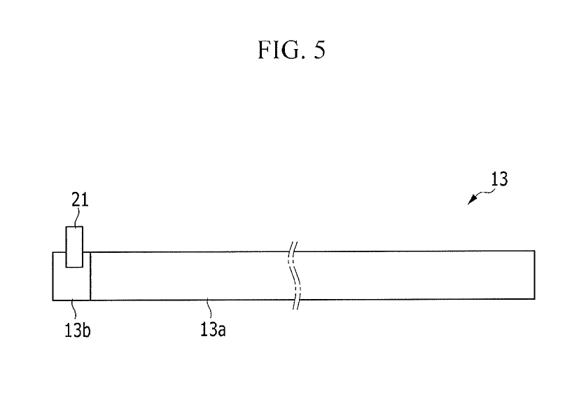

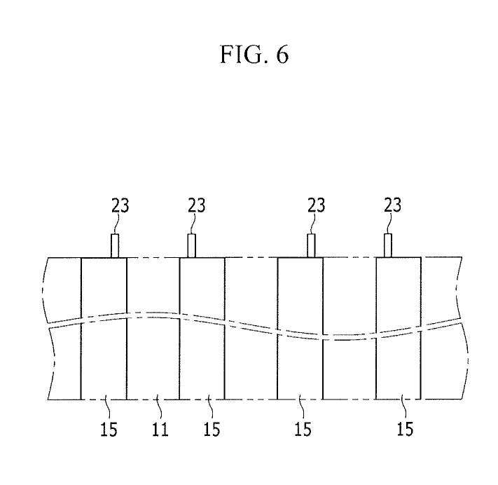

FIG. 4 shows a cross-sectional side view of a state in which a first electrode, a separator, and a second electrode of an electrode assembly are disposed, FIG. 5 shows a top plan view of a state in which a first current collecting tab is connected to a first electrode, and FIG. 6 shows a top plan view of a state in which a plurality of second electrodes are connected to a plurality of second current collecting tabs.

As shown in FIG. 4 to FIG. 6, the negative electrode 13 includes a coated region 13a formed by coating an active material on a metal plate current collector, and an uncoated region 13b formed as an exposed current collector on which the active material is not coated. The uncoated region 13b of the negative electrode 13 is formed on a first end of the spirally wound negative electrode 13.

The negative electrode 13 is disposed on a first portion of the separator 11, and the first current collecting tab (a positive current collecting tab, for example) 21 is connected to the uncoated region 13b. The first current collecting tab 21 is connected to the negative electrode 13 and is installed to connect the negative electrode 13 to the first electrode lead 31.

The positive electrode 15 may be disposed on a second portion of the separator 11 and be provided at a position facing the negative electrode 13 with the separator 11 therebetween.

A plurality of positive electrodes 15 separated from each other may be disposed on a lateral side of the separator 11. The positive electrodes 15 may be formed by a punching process, for example, using a press and may be disposed on the lateral side of the separator 11.

The positive electrode 15 may be formed to be rectangular, for example, according to the punching process and may be disposed on the lateral side of the separator 11. The positive electrode 15 may be formed to be rectangular according to the present exemplary embodiment or, alternatively, may be formed to have various shapes, such as partially round.

The positive electrodes 15 separated from each other may be disposed on the lateral side of the separator 11, and a second current collecting tab 23 may be protruded and connected to respective edges of the positive electrodes 15.

The positive electrodes 15 are disposed on the lateral side of the separator 11 to prevent the curved portion that is bent when the electrode assembly 10 is spirally wound as a roll from being damaged, such as by being cracked.

The positive electrodes 15 may be disposed on the lateral side of the separator 11 such that gaps between them may be different on an external side, where the spiral winding finishes, and an internal side, where the spiral winding begins.

The positive electrodes 15 are disposed with the different gaps in the length direction of the separator 11 so that the positive electrode 15 may be constantly provided on the lateral side of the electrode assembly 10 when the electrode assembly 10 is spirally wound like a roll.

The positive electrodes 15 may, for example, be punched by a press to have a rectangular shape with a height and a width corresponding to the width of the separator 11. As a result, the positive electrodes 15 may be disposed in parallel at a predetermined position of the electrode assembly 10 so that a connection of a second electrode tab (a positive current collecting tab, for example) 23 may be facilitated.

The positive electrodes 15 are disposed on the lateral side of the separator 11 and, even when the electrode assembly 10 is spirally wound, the positive electrodes 15 may not be disposed on the curved portion. To achieve this, the positive electrodes 15 may be disposed such that a maximum distance between respective sides is maintained and corresponds to the curved portion of the electrode assembly 10.

As described above, the positive electrodes 15 may not be disposed on the round curved portion of the electrode assembly 10 when the electrode assembly 10 is spirally wound, so that the positive electrode 15 is not damaged, such as by cracking due to the generation and gathering of stress when the electrode assembly 10 is spirally wound into a roll shape. As such, the durability of the electrode assembly 10 may be improved.

The positive current collecting tab 23 is connected to a plurality of positive electrodes 15.

The positive current collecting tab 23 may protrude from and be connected to the positive electrodes 15 at different positions. This arrangement allows the positive current collecting tab 23 to be provided at a constant position when the electrode assembly 10 is spirally wound, since the positive electrodes 15 are provided such that they face each other with respect to the center of the electrode assembly 10.

The positive current collecting tab 23 may protrude from and be connected to the electrode assembly 10. The positive current collecting tab 23 protrudes and is connected to the positive electrodes 15 at different positions so that it may protrude at a constant position when the electrode assembly 10 is spirally wound.

The positive current collecting tabs 23 may be connected to each other through welding and may be connected to the second electrode lead 33.

The first electrode lead 31 and the second electrode lead 33 may have a same shape, for example, and may be connected to the first current collecting tab 21 and the second current collecting tabs 23, respectively.

The first electrode lead 31 and the second electrode lead 33 may, respectively, include first connection leads 31a and 33a that are respectively connected to the first current collecting tab 21 and the second current collecting tab 23, and second connection leads 31b and 33b that respectively protrude from the first connection leads 31a and 33a.

The first connection leads 31a and 33a are connected to the first electrode lead 31 or the second electrode lead 33, and they may be formed to have a length in a width direction of the electrode assembly 10.

The second connection leads 31b and 33b may be connected to a center portion of the first connection leads 31a and 33a, respectively, in the length direction. In detail, first portions of the second connection leads 31b and 33b may be connected to the first connection leads 31a and 33a, respectively, and second portions of the second connection leads 31b and 33b may protrude outside the first connection leads 31a and 33a, respectively.

The case 40 is formed to establish a space for receiving the electrode assembly 10 and an electrolyte solution, and is formed to protect the electrode assembly 10. The case 40 may be a pouch type or a square type, for example. In the present exemplary embodiment, the case 40 will be exemplified as a pouch type.

The case 40 may include a body 41, a receiver 43 formed inside the body 41, and a cover 45 for covering the receiver 43.

The body 41 may include a bottom side 41a and a lateral side 41b extending from the bottom side 41a.

The receiver 43 signifies a space formed by the bottom side 41a and the lateral side 41b of the body 41. The receiver 43 receives the electrode assembly 10.

The body 41 may extend from an inlet of the receiver 43, that is, the lateral side 41b, and may form an encapsulator 41c.

The cover 45 may extend from an edge of the encapsulator 41c of the body 41.

The cover 45 may cover the receiver 43 and, with the encapsulator 41c of the body 41, may encapsulate the rechargeable battery.

A protective circuit module 50 may control charging and discharging of the electrode assembly 10 and may control an operation of the rechargeable battery 100. The protective circuit module 50 in which control elements 51 such as ICs are installed may prevent an overcurrent from being applied to the rechargeable battery 100.

Further, the protective circuit module 50 may include outer terminals 53 for connecting the rechargeable battery 100 to an external device.

The control elements 51 and the outer terminals 53 are exemplarily described to be formed on a same side of the protective circuit module 50 or, alternatively, they may be formed on different sides of the protective circuit module 50.

The protective circuit module 50 may be electrically connected to the first electrode lead 31 and the second electrode lead 33.

As described above, the rechargeable batteries 100 may be disposed and connected and the positive electrodes 15 separated from each other in the length direction of the separator 11. Therefore, the positive electrode 15 may not be provided on the curved portion of the lateral side when the electrode assembly 10 is spirally wound, thereby preventing the positive electrodes 15 from being damaged, such as by being cracked due to the gathering of stress.

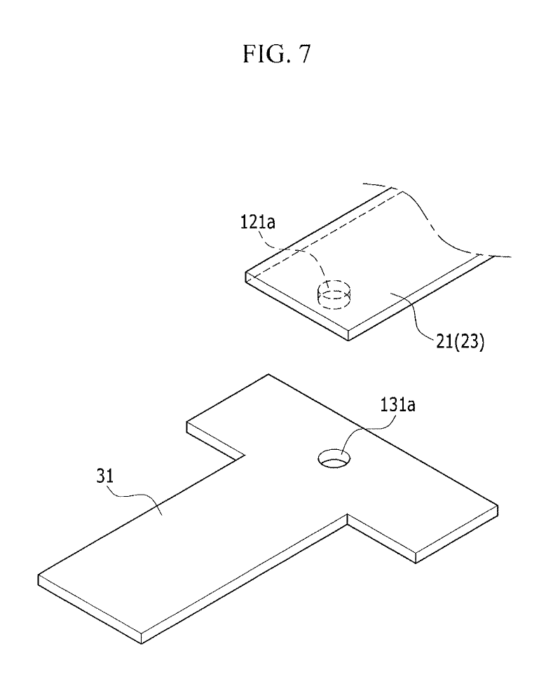

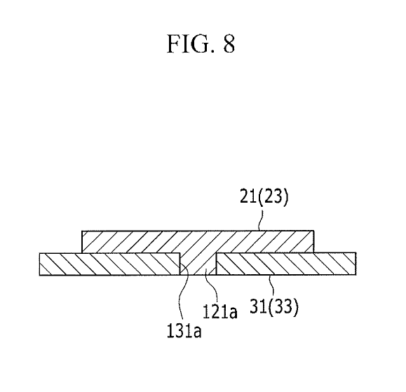

FIG. 7 shows a schematic exploded perspective view of a state in which a lead tab of a rechargeable battery according to a second exemplary embodiment is connected to a first electrode lead or a second electrode lead, and FIG. 8 shows a schematic cross-sectional view of a state in which a lead tab of FIG. 7 is connected to a first electrode lead or a second electrode lead. The same reference numerals as in FIG. 1 to FIG. 6 represent the same or similar members for performing the same or similar functions. No same reference numerals will be described.

As shown in FIG. 7 and FIG. 8, regarding the rechargeable battery according to a second exemplary embodiment, a protrusion 121a is formed on lead tabs 21 and 23 of an electrode assembly 10, and an indentation hole 131a into which the protrusion 121a is pressurized or pressed is formed in the first electrode lead 31 or the second electrode lead 33.

Therefore, the first electrode lead 31 or the second electrode lead 33 may be connected to the lead tabs 21 and 23 through welding when the protrusion 121a is inserted into the indentation hole 131a.

Therefore, the lead tabs 21 and 23 may be firmly connected to the first electrode lead 31 or the second electrode lead 33.

By way of summation and review, the electrode assembly of a rechargeable battery may be spirally wound in a roll shape and received in a case such that stress may gather at a curved portion on a lateral side when the electrode assembly is spirally wound. As a result, the rechargeable battery may be cracked by the stress generated from winding and its durability may be resultantly deteriorated.

Embodiments disclosed herein provide a rechargeable battery that may have improved durability. That is, disclosed herein is a rechargeable battery in which damage may be prevented when an electrode assembly is spirally wound. According to embodiments, a plurality of positive electrodes separated from each other may be disposed in the length direction of the separator. Therefore, the positive electrode may not be provided on the curved portion of the lateral side when the electrode assembly is spirally wound so that the curved portion may be prevented from being damaged (e.g., cracking) because of the gathered stress.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery comprising:
an electrode assembly including a separator, a first electrode disposed on a first portion of the separator, and a plurality of second electrodes separated from each other with the separator therebetween;
a case for receiving the electrode assembly;
a lead tab including a first current collecting tab connected to the first electrode and a second current collecting tab connected to the plurality of second electrodes;
a first electrode lead connected to the first current collecting tab; and
a second electrode lead connected to the second current collecting tab.

2. The rechargeable battery as claimed in claim 1, wherein
the first current collecting tab is connected to an uncoated region of the first electrode and protrudes from the first electrode to be connected to the first electrode lead.

3. The rechargeable battery as claimed in claim 1, wherein
the second current collecting tab includes a first end connected to the plurality of second electrodes and a protruded end protruding from the plurality of second electrodes, the protruded end being connected to the second electrode lead.

4. The rechargeable battery as claimed in claim 3, wherein
the plurality of second electrodes are disposed on a lateral side of the separator with different gaps therebetween.

5. The rechargeable battery as claimed in claim 4, wherein
the electrode assembly is curved at a curved portion where an uncoated region is formed and is spirally wound in a jellyroll shape, and
two second electrodes of the plurality of second electrodes are disposed with the curved portion therebetween and are disposed with a largest gap of the different gaps therebetween.

6. The rechargeable battery as claimed in claim 5, wherein
the plurality of second electrodes are disposed on the lateral side of the separator such that the different gaps increase from an internal side where the spiral winding begins to an external side where the spiral winding finishes.

7. The rechargeable battery as claimed in claim 6, wherein
the plurality of second electrodes are separated from each other and disposed on the lateral side of the separator, and two neighboring second electrodes are disposed to be inverted from each other when the electrode assembly is spirally wound.

8. The rechargeable battery as claimed in claim 6, wherein
the second current collecting tab is a plurality of second current collecting tabs that are welded to and combined with each other when the electrode assembly is spirally wound, the plurality of second current collecting tabs being connected to the second electrode lead.

9. The rechargeable battery as claimed in claim 1, wherein
a protrusion is formed on the lead tab and an indentation hole into which the protrusion is pressed is formed in the first electrode lead or the second electrode lead.
